(19) United States
(12) Patent Application Publication
(10) Pub. No.: US 2012/0173031 A1
(43) Pub. Date: Jul. 5, 2012

(54) REAL-TIME POWER POINT CALIBRATION

(75) Inventors: Gopakumar Parameswaran, Saratoga, CA (US); Mark Covaro, Sonoma, CA (US)

(73) Assignee: REDWOOD SYSTEMS, INC., Fremont, CA (US)

(21) Appl. No.: 12/981,039

(22) Filed: Dec. 29, 2010

(51) Int. Cl. G06F 1/26; H02J 7/35

(52) U.S. Cl. 700/295; 320/101

(57) ABSTRACT

A system for determining operating points of a photovoltaic array may power a load with the photovoltaic array and an alternate power source concurrently. One or more operating points of the photovoltaic array may be detected by adjusting the amount of power that the alternate power source supplies to the load while continuing to power the load with the alternate power source and the photovoltaic array. The operating points may be stored in a calibration table. Alternatively or in addition, the operating points may be detected by altering the amount of power that a battery charger receives from a photovoltaic array while the photovoltaic array powers the battery charger and the load concurrently.

### BACKGROUND

1. Technical Field

This application relates to photovoltaic cells and, in particular, to optimizing output of photovoltaic cells.

2. Related Art

Photovoltaic cells generate electricity that may power loads. The photovoltaic cells may be included in a solar panel or photovoltaic array. The photovoltaic cells convert solar energy into direct current (DC) via the photovoltaic effect.

The voltage across an output of the photovoltaic cells and the current produced by the photovoltaic cells may vary with a load powered by the photovoltaic cells. The voltage and current generated by the photovoltaic cells for one load may differ from the voltage and current generated for another load. Power may be expressed as voltage multiplied by current. Thus, under a particular lighting condition, the photovoltaic cells may generate a different amount of power depending on the load driven by the photovoltaic cells. The photovoltaic cells may generate a different amount of power depending on factors other than the load. For example, the amount of power that the photovoltaic cells generate may depend on the amount of light received by the solar panel, the amount of dirt accumulated on the panel, shading on the panel, the efficiency of the solar panel, and other factors.

### SUMMARY

A first system may determine operating points of a photovoltaic array. The system may include a paralleling power circuit and a control module. The paralleling power circuit may power a load from both the photovoltaic array and an alternate power source concurrently. The control module may alter the amount of power that the paralleling power circuit receives from the alternate power source while the paralleling power circuit continues to power the load from both the photovoltaic array and the alternate power source concurrently. The control module may determine one or more operating points of the photovoltaic array from sensor data, where the operating points may be reached in response to the alteration of the amount of power that the paralleling power circuit receives from the alternate power source.

An apparatus may include a paralleling power circuit and a control module. The paralleling power circuit may power a load with the photovoltaic array and the alternate power source at substantially the same time or simultaneously. The control module may modify the amount of power that the paralleling power circuit receives from the alternate power source. The load may be simultaneously powered by the photovoltaic array and the alternate power source during a controlled modification of the amount of power that the paralleling power circuit receives from the alternate power source. The control module may determine one or more operating points of the photovoltaic array from sensor data. The operating points may be reached in response to the modification of the amount of power that the paralleling power circuit receives from the alternate power source.

A method may determine operating points of a photovoltaic array. A load may be powered with the photovoltaic array and an alternate power source concurrently. The amount of power that the alternate power source supplies to the load may be adjusted while continuing to power the load through the alternate power source and the photovoltaic array concurrently. One or more operating points of the photovoltaic array may be established by processing sensor data. The operating points may be reached in response to adjusting the amount of power that the alternate power source supplies to the load.

A second system that determines operating points of a photovoltaic array may include a battery charger and a control module. The battery charger and a load may receive power from the photovoltaic array concurrently. The control module may adjust the amount of power that the battery charger receives from the photovoltaic array, while the photovoltaic array sources the battery charger and the load concurrently. The control module may determine one or more operating points of the photovoltaic array from sensor data. The operating points may be reached in response to the alteration of the amount of power that the battery charger receives.

Further objects and advantages of the present invention will be apparent from the following description, reference being made to the accompanying drawings wherein preferred embodiments of the present invention are shown.

### BRIEF DESCRIPTION OF THE DRAWINGS

The embodiments may be better understood with reference to the following drawings and description. The components in the figures are not necessarily to scale, emphasis instead being placed upon illustrating the principles of the invention. Moreover, in the figures, like-referenced numerals designate corresponding parts throughout the different views.

FIG. 1 illustrates an example of a calibration system in which a load is powered by both a photovoltaic array and an alternate power source concurrently during calibration;

FIG. 2 illustrates an example of a calibration system in which a photovoltaic array both powers a load and charges a battery during calibration;

FIG. 3 illustrates a flow diagram of the logic of a first example of a calibration system; and

FIG. 4 illustrates a flow diagram of the logic of a second example of a calibration system.

### DETAILED DESCRIPTION

Maximum power point tracking (MPPT) may optimize the output of a solar panel or a photovoltaic array. Maximum power point tracking involves adjusting current and voltage drawn from the photovoltaic array so that the power produced by the photovoltaic array falls within a range of a maximum power that the photovoltaic array is capable of generating. When receiving a fixed amount of light, the photovoltaic array may generate current and voltage according to an I-V curve. The I-V curve may include a collection of ordered pairs of (I, V), where I is current and V is voltage. Accordingly, the I-V curve of the photovoltaic array may represent a collection of possible operating points of the photovoltaic array. The I-V curve may be modeled using any suitable equation or data set. Alternatively or in addition, the I-V curve is known by measurements of the photovoltaic array or a similar photovoltaic array. The I-V curve may vary with environmental or circuit conditions. Factors affecting the I-V curve may include the amount of light received by the photovoltaic array, the amount of dirt accumulated on the panel, shading on the panel, the efficiency of the photovoltaic array, and other factors. Power may be expressed as current multiplied by voltage. Thus, for a particular I-V curve of the photovoltaic array, there may be a point on the I-V curve, (I_{max power}, V_{max power}), at which power is maximized. The point at which the power is maximized may be referred to as the maximum power point.

Just as the photovoltaic array has I-V curves, so do loads. For example, the I-V curve for a simple resistive load may be modeled as I=(1/R)×V, where R represents resistance. When the photovoltaic array powers the load, the amount of current flowing from the photovoltaic array may be substantially the same as the current flowing into the load. The voltage across the photovoltaic array may be the same as the voltage across the load. Therefore, when the I-V curve of photovoltaic array is plotted on the same graph as the I-V curve of the load, the intersection point may be the operating point, (Iₒₚₑᵣ, Vₒₚₑᵣ). Because the operating point may not be the maximum power point, the photovoltaic array may not be able to deliver the maximum power to a particular load. In some configurations, the operating point may be at the maximum power point, but the photovoltaic array may not be able to supply all of the power that a particular load demands.

A maximum power point tracker (MPPT) unit may alter the operating point to match the maximum power point. An input of the MPPT unit may be electrically coupled to the photovoltaic array. An output of the MPPT unit may be electrically coupled to the load. The MPPT unit may receive power from the photovoltaic array and supply at least a portion of the power to the load. The MPPT unit may control the relationship between the current and voltage at the input of the MPPT unit and the current and voltage at the output of the MPPT. As a result, the MPPT unit may adjust the power drawn from the photovoltaic array so that the photovoltaic array supplies a maximum power level at the maximum power point to the MPPT unit, while the MPPT unit powers the load at a current and voltage level different than the maximum power point. This is because the power into the MPPT unit, Pᵢₙ, may be substantially the same as the power out of the MPPT unit, Pₒᵤₜ, and because Pᵢₙ=Vᵢₙ·Iᵢₙ≈Pₒᵤₜ=Vₒᵤₜ·Iₒᵤₜ. The MPPT unit may include a power converter that establishes the relationship between the current and voltage at the input of the MPPT unit and the current and voltage at the output of the MPPT.

The MPPT unit may perform maximum power point tracking. As the maximum power point varies, the MPPT unit may adjust the relationship between the current and voltage at the input of the MPPT unit and the current and voltage at the output of the MPPT so that the photovoltaic array continues to operate at or near the maximum power point whenever possible. A microcontroller, for example, may determine the desired relationship and direct the power converter to set the desired relationship between the current and voltage at the input of the MPPT unit and the current and voltage at the output of the MPPT.

Maximum power point tracking may determine an optimum operating point based on current and voltage pairs included in one or more I-V curves of the photovoltaic array. The current and voltage pairs may be stored in a memory or database as a table. The table may be populated by disconnecting the load, coupling a test load, such as a capacitor or an element that provides a variable resistance, and measuring or detecting the current and voltage settings with sensors as the current and voltage of the photovoltaic array vary.

In some calibration systems, the characteristics of the I-V curve of the photovoltaic array may be determined without disconnecting power to the load. In addition, the photovoltaic array may operate at the maximum power point over time, even as the characteristics of the photovoltaic array change.

In one example, a load may be powered by both a photovoltaic array and an alternate power source concurrently using a paralleling power circuit. The alternate power source may include, for example, the AC (alternating current) power grid. The paralleling power circuit may include a diode bridge or ORing diodes. The amount of power supplied by the alternate source may be adjusted and, as a result, the operating point of the photovoltaic array may be moved along the I-V curve of the photovoltaic array. A calibration table may be rendered and/or stored in a computer readable medium or database with the current and voltage values detected as the operating point moves along the I-V curve.

In a second example, current from a photovoltaic array may be delivered to a load and a battery concurrently. The amount of current provided to the battery may be adjusted and, as a result, the operating point of the photovoltaic array may be moved along the I-V curve of the photovoltaic array. A calibration table may be rendered and/or stored in a computer readable medium or database with the current and voltage values detected as the operating point moves along the I-V curve.

### 1. Solar and Alternate Power Source Configuration.

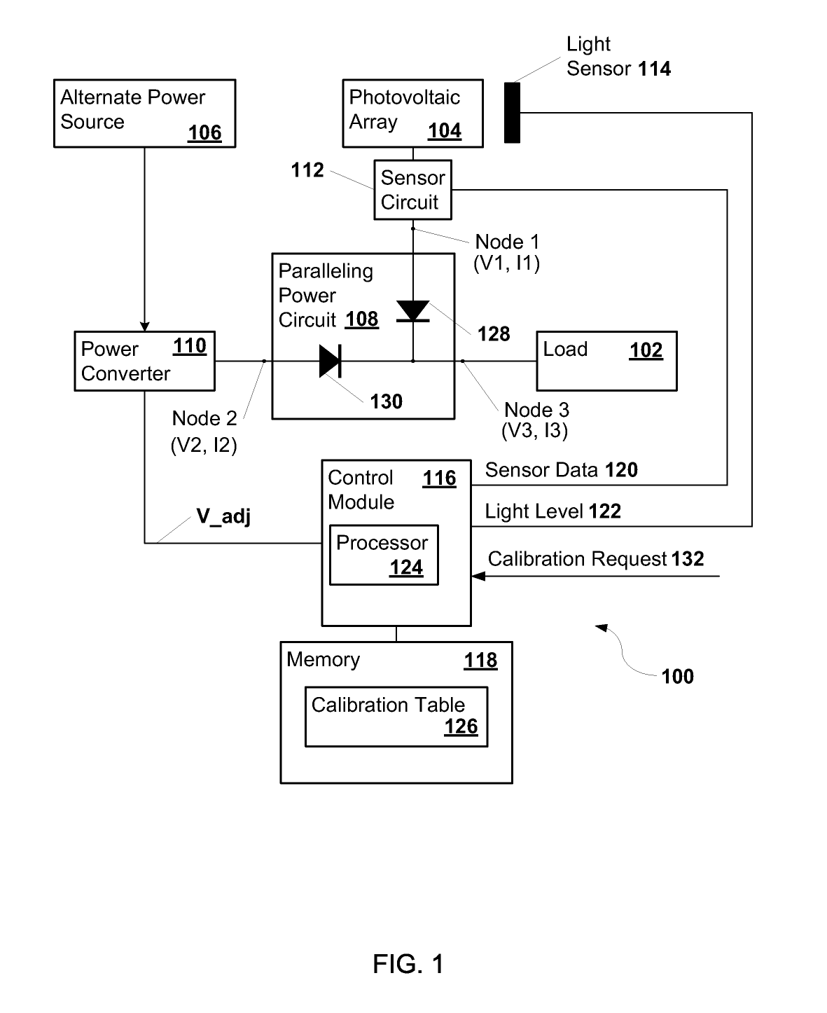

FIG. 1 illustrates an example of a calibration system 100 in which a load 102 is powered by both a photovoltaic array 104 and an alternate power source 106 concurrently during calibration. The system 100 may include a paralleling power circuit 108, a power converter 110, a sensor circuit 112, a light sensor 114, a control module 116, and a memory 118.

The load 102 may include any device or combination of devices that draws power. For example, the load 102 may include building lights, motors, actuators, fans, display devices, sensors, controllers, power converters, such as voltage to current power converters, battery chargers, batteries, or any other type of electronic device.

The photovoltaic array 104 may include one or more photovoltaic cells that generate direct current (DC). In one example, the photovoltaic array 104 may include one or more solar panels. The individual solar panels may be coupled in series, in parallel, or a combination thereof. Combining the solar panels in series may increase the maximum potential output voltage of the photovoltaic array 104. Combining the solar panels in parallel may increase the maximum potential output current of the photovoltaic array 104.

The alternate power source 106 may include any power source other than the photovoltaic array 104. Examples of the alternate power source 106 include an AC (alternating current) power source, one or more devices that convert mechanical energy into electrical energy (such as a generator and a wind turbine), a power grid, a DC (direct current) power source, a battery, a second photovoltaic array, or any other source of electricity.

The paralleling power circuit 108 may include any circuit that powers the load 102 with power received from two or more power sources concurrently. Examples of the paralleling power circuit 108 may include a diode bridge, ORing diodes, Bipolar junction transistors (BJTs) that may be configured to operate as diodes in a diode bridge, or a control circuit used in conjunction with a switch such as BJTs, thyristors, bidirectional triode thyristors, gate turn-off thyristors (GTOs), TRIACs (Triode for Alternating Current), silicon-controlled rectifiers (SCRs), or insulated gate bipolar transistors (IGBTs).

The power converter 110 may include any electrical or electro-mechanical device for converting electrical energy. For example, the power converter 110 may convert AC to DC, convert the voltage and/or current of an input of the power converter 110 to an altered voltage and/or current at an output of the power converter 110, or any combination thereof. Examples of the power converter 110 may include an AC/DC converter, a DC/DC converter, a switched-mode power supply, a buck-boost converter, a buck converter, a boost converter, a rectifier, an inverter, a transformer, or other devices.

The sensor circuit 112 may include a sensor that detects current flowing through a node, a sensor that detects a voltage at a node, or any combination thereof. For example, the sensor circuit 112 may include an operational amplifier to detect the voltage at the node, and an operational amplifier with a resistor to detect the current flowing through the node. The sensor circuit 112 may generate sensor data 120 that includes an indication of the voltage at the node, an indication of the current flowing through the node, or any combination thereof. In one example, the sensor data 120 may include a signal having a voltage amplitude that corresponds to the amount of current flowing through the node. In a second example, the sensor data 120 may include a digital value that identifies the voltage or current at the node. Alternatively or in addition, the sensor data 120 may include an output of an analog to digital converter that digitizes an analog signal generated by a sensor in the sensor circuit 112, where the analog to digital converter is included in the sensor circuit 112.

The light sensor 114 shown in FIG. 1 may comprise one or more optical detectors that detect light or other electromagnetic energy. The light sensor 114 may include a photosensor, a photodetector, a photoresistor, or any other device that detects a light level 122. The light level 122 may include an indication of the light level 122 using any suitable format. In one example, the light level 122 may include a signal having a voltage amplitude that corresponds to the amount light detected by the light sensor 114. In a second example, the light level 122 may include a digitized value of an analog signal generated by a sensor in the sensor circuit. Alternatively or in addition, the light level 122 may include a digital value that identifies the amount of light detected by the light sensor 114.

The memory 118 may be any now known, or later discovered, data storage device or combination of data storage devices. The memory 118 may include non-volatile and/or volatile memory, such as a random access memory (RAM), a read-only memory (ROM), an erasable programmable read-only memory (EPROM), or flash memory. Alternatively or in addition, the memory 118 may include an optical, magnetic (hard-drive) or any other form of data storage device.

The control module 116 may include any component that implements the logic of the system 100. For example, the control module 116 may include a processor 124 that executes instructions implementing the logic of the system 100. The instructions may be stored in memory such as in the memory 118 illustrated in FIG. 1 or in some other memory, such as memory in the control module 116.

The processor 124 may be in communication with the 118 memory. The processor 124 may also be in communication with additional components, such as a display and/or a network interface controller (NIC). The processor 124 may include a microprocessor, a general processor, central processing unit, server, application specific integrated circuit (ASIC), digital signal processor, field programmable gate array (FPGA), digital circuit, analog circuit, or any combination thereof. The processor 124 may include one or more elements operable to execute computer executable instructions or computer code embodied in the memory 118, in the control module 116, in some other memory, or a combination thereof.

The paralleling power circuit 108 may be configured to receive power from the alternate power source 106 via the power converter 110. The paralleling power circuit 108 may be further configured to receive power from the photovoltaic array 104 via the sensor circuit 112.

In FIG. 1, node 1, node 2, and node 3 correspond to a first input, a second input, and an output, respectively, of the paralleling power circuit 108. The paralleling power circuit 108 may receive power from the photovoltaic array 104 through node 1 and power from the alternate power source 106 through node 2. The paralleling power circuit 108 may provide power to the load through node 3. The amount of current flowing through node 1, node 2, and node 3, is designated I1, I2, and I3, respectively. The voltage at node 1, node 2, and node 3, is designated V1, V2, and V3, respectively. The sensor circuit 112 at node 1 may provide an indication of I1 and V1 to the control module 116. Other sensor circuits, which may measure or detect an electrical characteristic and/or may be similar to the sensor circuit 112 at node 1, may be coupled in series or parallel with nodes 2 and 3 or with devices coupled to those nodes. Some of the sensor circuits may provide an indication of I2, I3, V2, and V3 to the control module 116.

The light sensor 114 may be positioned adjacent to the photovoltaic array 104. The light sensor 114 may be included in, or be coupled to, the photovoltaic array 104. For example, the light sensor 114 may be on a tracking mechanism or frame on which the photovoltaic array 104 is mounted. Alternatively or in addition, the light sensor 114 may be positioned near enough to the photovoltaic array 104 that the light level 122 detected by the light sensor 114 is indicative of the amount of light received by the photovoltaic array 104.

During operation of the system 100, the load 102 may be powered by both the photovoltaic array 104 and the alternate power source 106 concurrently during calibration. In particular, the paralleling power circuit 108 may power the load 102 with both the photovoltaic array 104 and the alternate power source 106.

In one example, the photovoltaic array 104 may generate less power than is drawn by the load 102 under typical conditions. The alternate power source 106 may supply the rest of the power drawn by the load 102.

The power converter 110 may generate an output current, I2, at an output voltage, V2, at node 2 using power drawn from the alternate power source 106. The power converter 110 may receive a control signal, V_adj, that controls the output voltage, V2, of the power converter 110. In one example, the power converter 110 includes a buck-boost converter (step up or down), and the ratio between an output voltage and an input voltage of the power converter 110, Vₒᵤₜ/Vᵢₙ, may equal −D/(1−D), where D is the duty cycle of V_adj. The negative sign may be ignored by switching leads on an input or an output of the power converter 110. In a second example, the power converter 110 includes a buck converter (step down), and Vₒᵤₜ/Vᵢₙ may equal D. In a third example, the power converter 110 includes a boost converter (step up), and Vₒᵤₜ/Vᵢₙ may equal 1/(1−D).

The light sensor 114 may detect the amount of light present at the photovoltaic array 104. The light sensor may supply the light level 122 to the control module 116.

The control module 116 may also receive the light level 122 from the light sensor 114. The control module may receive the sensor data 120 that includes indications of current and voltage at one or more nodes in the system 100, such as I1, I2, I3, V1, V2, and V3.

The control module 116 may maintain a calibration table 126 in the memory 118. For each particular light level, the calibration table 126 may include one or more pairs of current and voltage values. The current and voltage pairs may correspond to points on the I-V curve of the photovoltaic array 104 for a particular light level. The I-V curve may be different for different light levels. Table 1 below illustrates an example of the calibration table 126.

TABLE 1

| Light Level | Current and Voltage Pairs Corresponding to Light Level |
|---|---|
| L₁ | I₁₁, V₁₁; I₁₂, V₁₂; I₁₃, V₁₃; . . . |
| L₂ | I₂₁, V₂₁; I₂₂, V₂₂; I₂₃, V₂₃; . . . |
| . | |
| . | |
| . | |
| L_{N} | I_{N1}, V_{N1}, I_{N2}, V_{N2}; I_{N3}, V_{N3}; . . . |

Based on the calibration table 126, the control module may cause the photovoltaic array 104 to operate at the maximum power point or at some other target power level during normal operation of the system 100. When operating at the target power level, the photovoltaic array 104 may operate at a target current-voltage pair (I_{target}, V_{target}). The control module 116 may receive the light level 122 from the light sensor 114. The control module 116 may process the values in the calibration table 126 to determine what current-voltage pair (Iₙₘ, Vₙₘ) corresponding to the detected light level, Lₙ, provides the maximum power or other target power level, where n identifies the light level 122 in the calibration table 126 and m identifies the current-voltage pair among the current-voltage pairs for the light level 122. The power corresponding to each of the operating points may be determined by multiplying the current and the voltage at the operating point. The control module 116 may select the appropriate current-voltage pair (Iₙₘ, Vₙₘ) from the pairs in the calibration table 126. The selected current-voltage pair may be the target current-voltage pair (I_{target}, V_{target}). Alternatively or in addition, the control module 116 may extrapolate the target current-voltage pair (I_{target}, V_{target}) from the current-voltage pairs in the calibration table 126 based on a mathematical model of the I-V curve of the photovoltaic array.

From the target current-voltage pair (I_{target}, V_{target}), the control module 116 may determine what V_adj causes the photovoltaic array 104 to generate V_{target} at node 1. If the photovoltaic array 104 generates V_{target} at node 1, then V1 equals V_{target} and I1 equals I_{target}. In one example, the paralleling power circuit 108 may include a first diode 128 between node 1 and node 3, and a second diode 130 between node 2 and node 3. Because the voltage drop across each one of the diodes 128 and 130 may be the substantially the same, V1 may be substantially the same as V2. Substantially the same means within a range that accounts for normal variation due to environmental changes and circuit tolerances. In one example, the first and second diodes 128 and 130 may comprise matched diodes formed on a same die, such as rectangular piece of a semiconductor wafer, so the voltage drops of the diodes 128 and 130 may be the same. In a second example, V1 and V2 may vary slightly due to variations between the first and second diodes 128 and 130, but may lie within an accepted predetermined tolerance range. Accordingly, the control module 116 may set V_adj such that the output voltage, V2, of the power converter 110 is V_{target}. Accordingly, V1 may be equal to or substantially the same as, V2, which equals V_{target}. Alternatively or in addition, the control module 116 may set V_adj so that the output voltage, V2, of the power converter 110 is V_{target}, and then adjust V_adj until the sensor circuit 112 indicates that V1 is V_{target}. Thus, based on the calibration table 126, the control module may cause the photovoltaic array 104 to operate at the maximum power point or at some other target power level during normal operation.

If the control module 116 sets the output voltage, V2, of the power converter 110 to the maximum power point voltage, but the load 102 draws less power than the photovoltaic array 104 is capable of providing at the maximum power point, then V2 may less than V1. For example, if the load 102 draws no current, then V1 may equal the open circuit voltage of the photovoltaic array 104. The maximum power point voltage is less than the open circuit voltage of the photovoltaic array 104. Therefore, V2 may be less than V1 if the load 102 draws no current.

If V2 is less than V1, then V2 may be less than the voltage, V3, at the load 102, because V3 may be the same as V1 or equal to V1 minus the voltage drop of the first diode 128. If V2 is less than V3, then no current may flow from the power converter 110 through the second diode 130 to the load 102. Accordingly, if V2 is less than V3, then the photovoltaic array 104 may supply all of the load current, I3, to the load 102.

As the load current, I3, increases, then V1 starts decreasing along I-V curve of the photovoltaic array 104 until V1 reaches V2. If V1 and V2 are substantially the same, then a portion of the load current, I3, may be provided by the photovoltaic array 104 corresponding to the current at the point in the I-V curve where V1 equals V2. The remaining portion of the load current, I3, may be provided by the alternate power source 106. If the load current, I3, is less than the photovoltaic array 104 is capable of supplying when V1 equals V2, then the load current, I3, may be supplied entirely from the photovoltaic array.

When initializing a system 100, the calibration table 126 may start with a default table for the photovoltaic array 104. The default table may be supplied by the photovoltaic array manufacturer or some other supplier. Over time, the control module 116 may update the calibration table 126 with data collected in batch or real-time through the sensor data 120. Alternatively, the calibration table 126 may initially be empty and be populated and updated over time with data collected in batch or real-time. The control module 116 may update the calibration table 126 in a calibration mode. In calibration mode, the load 102 may continue to be powered by both the photovoltaic array 104 and the power converter 110 at the same time.

In some examples, each of the entries in the calibration table 126 may be considered valid for a predetermined period of time. Accordingly, each of the entries may be associated with metadata that may include a corresponding expiration time, a last updated time, or any other indication of the length of time that the entries are valid. The control module 116 may enter calibration mode, and update the entry or entries corresponding to the light level 122 if: (1) the entry or entries have expired; and (2) the load 102 is drawing more power than is provided by the photovoltaic array 104. Alternatively or in addition, the control module 116 may update the entry or entries corresponding to the light level 122 in response to a calibration request 132 received from, for example, a user, and the load 102 is drawing more power than can be provided by the photovoltaic array 104. Alternatively or in addition, the calibration request 132 may be generated by a device, such as a timer circuit or a computing device. In one example, the calibration request 132 may be generated according to a policy setting. The policy setting may indicate that the calibration request 132 is to be generated whenever particular conditions are satisfied. For example, the calibration request 132 may be generated at particular times of the day or week and/or based on detection of particular data patterns. To update an entry, the control module 116 may adjust V_adj until the current, I1, generated by the photovoltaic array 104 matches the current in the entry being updated. The control module 116 may receive the voltage, V1, at the photovoltaic array from the sensor circuit 112. The control module 116 may update the corresponding current-voltage pair in the entry in the calibration table 126.

Alternatively or in addition, the control module 116 may adjust V_adj until the voltage, V1, generated by the photovoltaic array 104 matches the voltage in the entry being updated. The control module 116 may receive the current, I1, generated by the photovoltaic array 104 from the sensor circuit 112. The control module 116 may update the corresponding current-voltage pair in the entry in the calibration table 126.

Alternatively or in addition, the control module 116 may cause the voltage, V1, or current, I1, generated by the photovoltaic array 104 to vary over a range of values. For example, by adjusting V_adj, the control module 116 may direct the voltage, V1, generated by the photovoltaic array 104 to vary across a range of values. As the V1 varies, the control module 116 may determine operating points on the I-V curve of the photovoltaic array 104 from the sensor data 120 received for the light level 122.

To facilitate updating the calibration table 126, the photovoltaic array 104 may be sized to have a maximum power point that falls within a range corresponding to the output of the power converter 110. In one example, the photovoltaic array 104 may be sized to have a maximum output power that is less than the load 102 draws under normal conditions. Accordingly, the control module 116 may be able to update the calibration table 126 under normal conditions.

Alternatively or in addition, the control module 116 may switch off one or more solar panels included in the photovoltaic array 104 so that the load 102 draws more power than is provided by, or is available from, the photovoltaic array 104. For example, the photovoltaic array 104 may include two solar panels connected in series. The control module 116 may short a first one of the solar panels during calibration mode, and detect current-voltage pairs from the sensor data 120 for a second one of the solar panels. The control module 116 may short the second one of the solar panels during calibration mode, and detect current-voltage pairs from the sensor data 120 for the first one of the solar panels. The control module 116 may determine the current-voltage pairs for the photovoltaic array 104 by adding the current-voltage pairs detected individually for the first and second solar panels.

The calibration system 100 may include additional, fewer, or different components. For example, the calibration system 100 may not include the sensor circuit 112 or the light sensor 114. In another example, the calibration system 100 may include a computing device in communication with the control module 116, where the computing device includes the calibration table 126. In still another example, the calibration system 100 may include a display or other device for communicating with a user.

The components of the calibration system 100 may also include additional, fewer, or different components. For example, the paralleling power circuit 108 may include the sensor circuit 112. In another example, the control module 116 may include the memory 118 or other components, such as memory other than the memory 118 that includes the calibration table 126. In yet another example, the calibration system 100 may not include sensor circuits to detect voltages or current at node 2 or node 3. For example, the control module 116 may deduce the voltage and current (V3, I3) at node 3 from load information. The load information may include information about one or more loads.

The load information may be received from an intelligent power device. The intelligent power device may include a device that both powers load devices and communicates with load devices or devices at or near the load devices. Alternatively or in addition, the intelligent power device may collect information about the loads that the intelligent power device powers. An example of the intelligent power device includes the power device described in U.S. patent application Ser. No. 12/790,038, entitled “SMART POWER DEVICE,” filed May 28, 2010. The load 102 illustrated in FIG. 1 may include the intelligent power device. Alternatively, or in addition, the intelligent power device may include the calibration system 100. The control module 116 may receive the load information from the intelligent power device. For example, the intelligent power device may include a number of channels that power load devices, and the load information may include Vₙ and Iₙ, where n ranges from 1 to the number of channels, and Vₙ and Iₙ correspond to the voltage and current, respectively, supplied to each one of the channels. Thus, the control module 116 may deduce the voltage and current (V3, I3) at node 3 from the load information.

In another example, the load information may also include power usage statistics. For example, the power usage statistics may indicate that more power is drawn by the load 102 on weekdays than on weekends. In some configurations, calibration mode may not be possible if the load does not draw enough power to perform calibration. Accordingly, the control module 116 may use the load information to schedule calibration. For example, the control module 116 may enter calibration mode just prior to an entry in the calibration table 126 expiring if the entry is to expire on a coming weekend.

### 2. Solar and Battery Configuration.

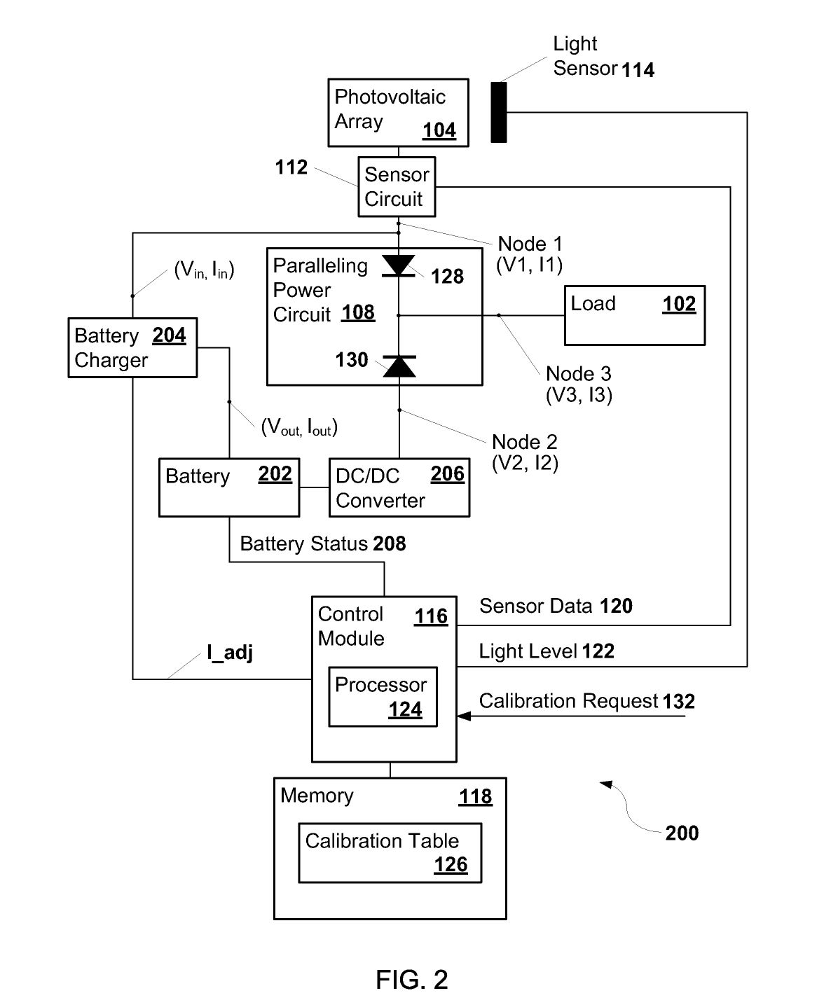

FIG. 2 illustrates an example of a calibration system 200 in which the photovoltaic array 104 both powers the load 102 and charges a battery 202 during calibration. Instead of varying the amount of power supplied to the load 102 by the alternate power source 106 in order to modify the operating point of the photovoltaic array 104 during calibration, the control module 116 may vary the amount of power that the battery 202 receives from the photovoltaic array 104. The system 200 may include the light sensor 114, a battery charger 204, a DC/DC converter 206, the paralleling power circuit 108, the control module 116, and the memory 118 that includes the calibration table 126.

The battery 202 may include any device or combination of devices that converts electrical energy to stored energy and converts the stored energy into electrical energy. For example, the battery 202 may include one or more electrochemical cells that convert electricity into stored chemical energy and the stored chemical energy into electrical energy, such as galvanic cells, electrolytic cells, fuel cells, flow cells, and voltaic piles.

The battery charger 204 may include any device or combination of devices that supplies an adjustable amount of electric current to a battery, such as to the battery 202 illustrated in FIG. 2. In one example, the battery charger 204 may include a DC/DC converter to control the relationship between an input (Vᵢₙ, Iᵢₙ) of the battery charger 204 and an output (Vₒₙₜ, Iₒᵤₜ) of the battery charger 204. The battery charger 204 may charge the battery 202 at an output voltage, Vₒᵤₜ, from power received from the photovoltaic array 104 at an input voltage, Vᵢₙ. The relationship between Vᵢₙ and Vₒᵤₜ may be controlled by a signal, I_adj. Alternatively or in addition, the battery charger 204 may charge the battery 202 with an output current, Iₒᵤₜ, while drawing an input current, Iᵢₙ, from the photovoltaic array 104. The relationship between Iᵢₙ and Iₒᵤₜ may be controlled by the signal, I_adj.

The DC/DC converter 206 may include an electronic circuit that converts a source of direct current (DC) from one voltage level to another. Examples of the DC/DC converter include a switched-mode power supply, a buck-boost converter, a buck converter, a boost converter.

The paralleling power circuit 108 may receive power from the photovoltaic array 104 via the sensor circuit 112. The paralleling power circuit 108 may receive power from the battery 202 via the DC/DC converter 206. The paralleling power circuit 108 may power the load 102 with power received concurrently or individually from the photovoltaic array 104 and the battery 202.

In FIG. 2, node 1, node 2, and node 3 correspond to a first input, a second input, and an output, respectively, of the paralleling power circuit 108. The paralleling power circuit 108 may receive power from the photovoltaic array 104 through node 1 and power from the battery 202 through node 2. The paralleling power circuit 108 may source power to the load through node 3. The amount of current flowing through node 1, node 2, and node 3, is designated I1, I2, and I3, respectively. The voltage at node 1, node 2, and node 3, is designated V1, V2, and V3, respectively. The sensor circuit 112 at node 1 may provide an indication of I1 and V1 to the control module 116. Sensor circuits, including those that may be similar to the sensor circuit 112 at node 1, may be present at nodes 2 and 3 and provide an indication of I2, I3, V2, and V3 to the control module 116 through a wireless or tangible bus. The battery charger 204, like the paralleling power circuit 108, may draw current from the photovoltaic array 104 through node 1.

The light sensor 114 may be positioned adjacent to the photovoltaic array 104. The light sensor 114 may be included in or be coupled to the photovoltaic array 104. For example, the light sensor 114 may be on a tracking mechanism or frame on which the photovoltaic array 104 is mounted. Alternatively or in addition, the light sensor 114 may be positioned near the photovoltaic array 104 such that the light level 122 detected by the light sensor 114 is indicative of the amount of light received by the photovoltaic array 104.

During normal operation of the system 200, the control module 116 may operate the photovoltaic array 104 at a target operating point by adjusting the amount of power received by the battery charger 204. The control module may determine the target operating point by determining a suitable target current-voltage pair (I_{target}, V_{target}) from the calibration table 126. The control module 116 may adjust the relationship between Iᵢₙ and Iₒᵤₜ at the battery charger 204 with the signal, l_adj, in order to set the charge current, Iₒᵤₜ, that is supplied to the battery 202. By adjusting Iₒᵤₜ, the control module 116 may directly adjust the current, I1, supplied by the photovoltaic array 104 through node 1. The current, I1, supplied by photovoltaic array 104 may be the sum of the load current, I3, and the battery charge current, Iₒᵤₜ. As I1 changes, V1 moves to a corresponding voltage on the I-V curve of the photovoltaic array 104. Alternatively or in addition, the control module 116 may adjust the relationship between Vᵢₙ and Vₒᵤₜ at the battery charger 204 with the signal, I_adj, in order to set the charge current, Iₒᵤₜ, supplied to the battery 202. Accordingly, by adjusting I_adj, the control module 116 may move V1 and I1 to the target current-voltage pair (I_{target}, V_{target}) on the I-V curve of the photovoltaic array 104.

If the photovoltaic array 104 can supply more power than the load 102 consumes, then the control module 116 may update the calibration table 126 in calibration mode. During calibration mode, the control module 116 may alter the amount of power that the battery charger 204 receives from the photovoltaic array 104 while the photovoltaic array 104 continues to power both the battery charger 204 and the load 102 concurrently.

For example, the control module 116 may adjust the relationship between Vᵢₙ and Vₒₙₜ at the battery charger 204 with the signal, I_adj, in order to alter the amount of power that the battery charger 204 receives from the photovoltaic array 104. In response to altering the amount of power that the battery charger 204 receives, the operating point (V1, I1) of the photovoltaic array 104 may move along the I-V curve of the photovoltaic array 104. The control module 116 may determine one or more operating points of the photovoltaic array 104 from the sensor data 120 received from the sensor circuit 112. The determined operating points are reached in response to the alteration of the amount of power that the battery charger 204 receives.

The control module 116 may adjust I_adj in calibration mode so that the operating point of the photovoltaic array 104 reaches a particular point on the I-V curve that corresponds to an entry in the calibration table 126. The control module 116 may receive the sensor data 120 from the sensor circuit 112 after adjusting I_adj. From the sensor data 120, the control module 116 may determine V1 and I1. The control module 116 may verify the accuracy of the corresponding entry in the calibration table 126 and update the entry accordingly. Alternatively or in addition the control module 116 may populate an empty calibration table 126 with the operating points detected and/or determined during calibration mode. The control module 116 may update or populate the calibration table 126 with operating points corresponding to the light level 122 detected by the light sensor 114.

The DC/DC converter 206 may control the current, I2, and/or the voltage, V2, supplied by the battery 202 to the paralleling power circuit 108. The output voltage, V2, of the DC/DC converter 206 may be set to a value lower than the output voltage, V1, of the photovoltaic array 104 so that the DC/DC converter 206 will not supply any current from the battery 202 if the photovoltaic array 104 can fully power the load 102. In one example, the output voltage, V2, of the DC/DC converter 206 may be dynamically controlled by the control module 116. In a second example, output voltage, V2, of the DC/DC converter 206 may be statically set.

The photovoltaic array 104 may be sized to have a maximum output power that is greater than the load 102 draws under typical conditions. As a result, the photovoltaic array 104 may generate enough power to charge the battery 202 in addition to powering the load 102 under typical conditions. Furthermore, the control module 116 may be able to update the calibration table 126 under typical conditions.

The control module 116 may receive a battery status 208 from the battery 202 or the battery charger 204. The battery status may indicate whether the battery is fully charged, a charge level of the battery, a battery temperature, or any other information about the battery 202. If the battery 202 is fully charged or above a threshold charge level, then the control module 116 may not determine the operation points in calibration mode. Alternatively, the control module 116 may direct the DC/DC converter 206 to increase the voltage, V2, at node 2 so that the battery feeds the load 102 and drains the charge level of the battery 202. Once the battery 202 is partially drained, the control module 116 may determine the operation points in calibration mode.

The control module 116 may enter calibration mode, and update the entry or entries corresponding to the light level 122 if: (1) the entry or entries have expired; and (2) the load 102 is drawing less power than can be provided by the photovoltaic array 104. Alternatively or in addition, the control module 116 may update the entry or entries corresponding to the light level 122 in response to the calibration request 132 received from, for example, a user, and if the load 102 is drawing less power than can be provided by the photovoltaic array 104.

The calibration system 200 may include additional, fewer, or different components. For example, the system 200 may include the photovoltaic array 104. In another example, the system 200 may not include the DC/DC converter 206. The components of the calibration system 200 may include additional, fewer, or different components.

The calibration system may be a combination of the calibration system 100 illustrated in FIG. 1 and the calibration system 200 illustrated in FIG. 2. For example, the paralleling power circuit 108 may power the load 102 with the photovoltaic array 104, the alternate power source 106, and the battery 202 concurrently or individually. Alternatively, the calibration system may be a hybrid of the calibration systems 100 and 200 illustrated in FIGS. 1 and 2. For example, the alternate power source 106 illustrated in FIG. 1 may include the battery 202 illustrated in FIG. 2, and the power converter 110 illustrated in FIG. 1 may include the DC/DC converter 206 illustrated in FIG. 2.

The control module may perform the features of both calibration systems 100 and 200. For example, the control module 116 may modify the amount of power that the paralleling power circuit 108 receives from the alternate power source 106 in response to a determination that the load 102 consumes more power than the photovoltaic array 104 can provide; and the control module 116 may to alter the amount of power that the battery charger 204 receives from the photovoltaic array 104 in response to a determination that the load 102 consumes less power than the photovoltaic array 104 can provide. Alternately, the calibration systems 100 and 200 may be physically separate and distinct systems. The control module 116 in each system 100 or 200 may implement the features specific to the system 100 or 200.

The calibration systems 100 and 200 may be implemented in many different configurations. For example, although the control module 116 is described as including hardware, such as the processor 124, the control module 116 may be implemented as computer-executable instructions or as data structures stored in memory.

Although some features may be described as stored in computer-readable memories (e.g., as logic implemented as computer-executable instructions or as data structures in memory), one or more components of the systems 100 and 200 and corresponding logic and data structures may be stored on, distributed across, or read from machine-readable media. Examples of the machine-readable media include hard disks, floppy disks, CD-ROMs, and flash memory drives.

The systems 100 and 200 may be implemented with additional, different, or fewer entities. As one example, the processor 124 may be implemented as a microprocessor, a microcontroller, a DSP, an application specific integrated circuit (ASIC), discrete logic, or a combination of other types of circuits or logic. As another example, the memory 118 may be a non-volatile and/or volatile memory, such as a random access memory (RAM), a read-only memory (ROM), an erasable programmable read-only memory (EPROM), flash memory, any other type of memory now known or later discovered, or any combination thereof. The memory 118 may include an optical, magnetic (hard-drive) or any other form of data storage device.

The processing capability of the systems 100 and 200 may be centralized or distributed among multiple entities, such as among multiple processors and memories, optionally including multiple distributed processing systems. Parameters, databases, and other data structures may be separately stored and managed, may be incorporated into a single memory or database, may be logically and physically organized in many different ways, and may implemented with different types of data structures such as linked lists, hash tables, or implicit storage mechanisms. Logic, such as programs or circuitry, may be combined or split among multiple programs, distributed across several memories and processors, and may be implemented in a library, such as a shared library (e.g., a dynamic link library (DLL)).

The processor 124 may be one or more devices operable to execute computer executable instructions or computer code embodied in the memory 118 or in other memory to perform the features of the control module 116. The computer code may include instructions executable with the processor 124. The computer code may include embedded logic. The computer code may be written in any computer language now known or later discovered, such as C++, C#, Java, Pascal, Visual Basic, Perl, Hypertext Markup Language (HTML), JavaScript, assembly language, shell script, or any combination thereof. The computer code may include source code and/or compiled code.

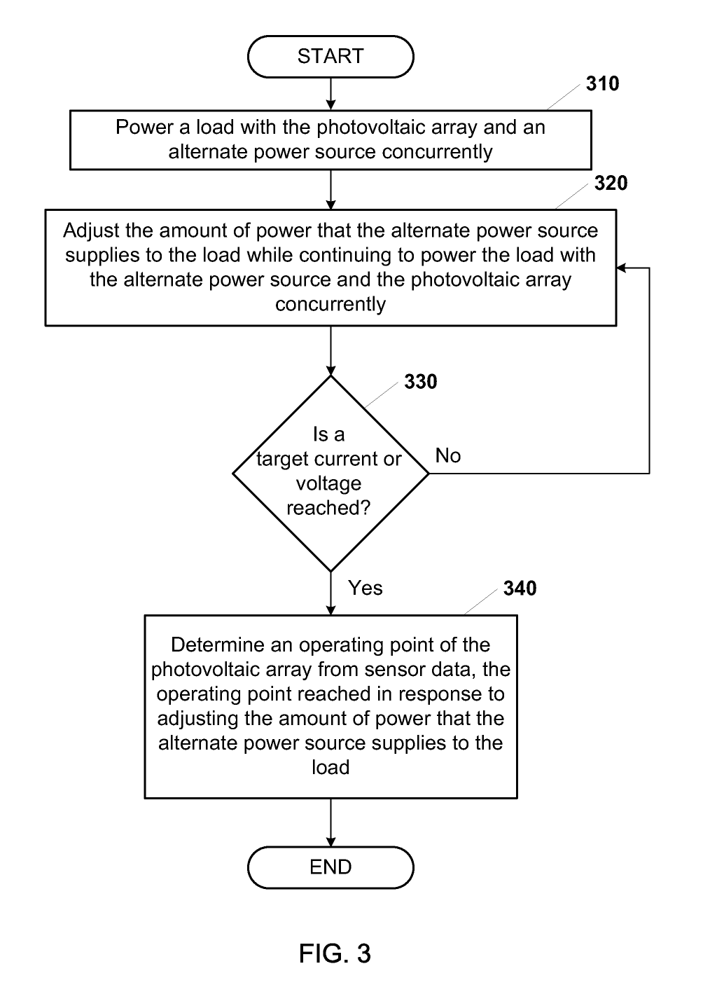

FIG. 3 illustrates a flow diagram of the logic of a first example of the calibration system 100. The logic may include additional, different, or fewer operations. The operations may be executed in a different order than illustrated in FIG. 3.

In a first operation, the load 102 may be powered by the photovoltaic array 104 and the alternate power source 106 concurrently (310). The amount of power that the alternate power source 106 supplies to load 102 may be adjusted while continuing to power the load 102 with the photovoltaic array 104 and the alternate power source 106 concurrently (320).

In one example, an indication of current or voltage detected at the photovoltaic array 104 may be used to determine whether an output of the photovoltaic array 104 has reached a target current or voltage (330). For example, the indication may be included in the sensor data 120.

If the target current or voltage is not reached, then the amount of power that the alternate power source 106 supplies to load 102 may be adjusted again (320). Alternatively, if the target current or voltage is reached, then the operating point of the photovoltaic array 104 may be determined from the sensor data 120 (340). For example, both the current and the voltage of the operating point may be extracted from the sensor data 120.

In one example, the operation may end by updating the calibration table 126. In a second example, the operation may end by determining additional operating points of the photovoltaic array 104 by returning to the operation of adjusting the amount of power that the alternate power source 106 supplies to load 102 (320).

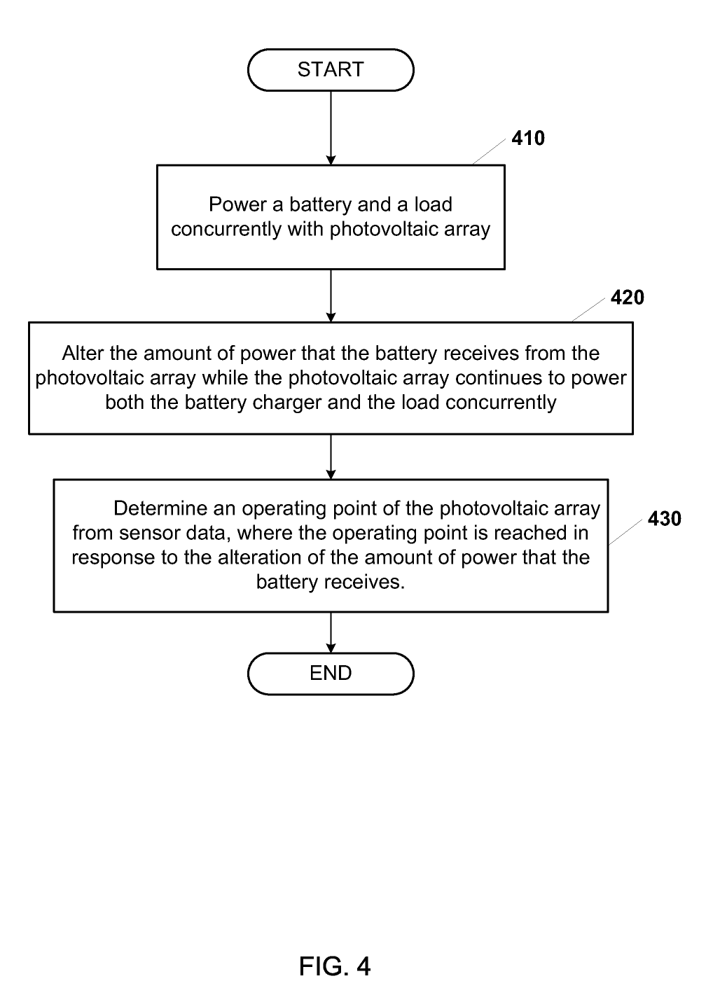

FIG. 4 illustrates a flow diagram of the logic of a second example of the calibration system 200. The logic may include additional, different, or fewer operations. The operations may be executed in a different order than illustrated in FIG. 4.

In a first operation, the battery 202 and the load 102 may be powered concurrently by the photovoltaic array 104 (410). In a second operation, the amount of power that the battery 202 receives may be altered while the photovoltaic array 104 continues to power both the battery 202 and the load 102 (420). In a third operation, an operating point of the photovoltaic array 104 may be determined from the sensor data 120, where the operating point is reached in response to the alteration of the amount of the power that the battery 202 receives 430 (430).

In one example, the operation may end by updating the calibration table 126. In a second example, the operation may end by determining additional operating points of the photovoltaic array 104 by returning to the operation of altering the amount of power that the battery 202 receives (420).

All of the discussion, regardless of the particular implementation described, is exemplary in nature, rather than limiting. For example, although selected aspects, features, or components of the implementations are depicted as being stored in memories, all or part of systems and methods consistent with the innovations may be stored on, distributed across, or read from other computer-readable storage media, for example, secondary storage devices such as hard disks, floppy disks, and CD-ROMs; or other forms of ROM or RAM either currently known or later developed. The computer-readable storage media may be non-transitory computer-readable media, which includes CD-ROMs, volatile or non-volatile memory such as ROM and RAM, or any other suitable storage device. Moreover, the various modules are but one example of such functionality and any other configurations encompassing similar functionality are possible.

Furthermore, although specific components of innovations were described, methods, systems, and articles of manufacture consistent with the innovation may include additional or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many ways. The components may operate independently or be part of a same program. The components may be resident on separate hardware, such as separate removable circuit boards, or share common hardware, such as a same memory and processor for implementing instructions from the memory. Programs may be parts of a single program, separate programs, or distributed across several memories and processors.

The respective logic, software or instructions for implementing the processes, methods and/or techniques discussed above may be provided on computer-readable media or memories or other tangible media, such as a cache, buffer, RAM, removable media, hard drive, other computer readable storage media, or any other tangible media or any combination thereof. The tangible media include various types of volatile and nonvolatile storage media. The functions, acts or tasks illustrated in the figures or described herein may be executed in response to one or more sets of logic or instructions stored in or on computer readable media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one embodiment, the instructions are stored on a removable media device for reading by local or remote systems. In other embodiments, the logic or instructions are stored in a remote location for transfer through a computer network or over telephone lines. In yet other embodiments, the logic or instructions are stored within a given computer, central processing unit (“CPU”), graphics processing unit (“GPU”), or system.

While various embodiments of the innovation have been described, it will be apparent to those of ordinary skill in the art that many more embodiments and implementations are possible within the scope of the innovation. Accordingly, the innovation is not to be restricted except in light of the attached claims and their equivalents.

What is claimed is:

1. A system for determining operating points of a photovoltaic array, the system comprising:
a paralleling power circuit configured to power a load from the photovoltaic array and an alternate power source concurrently;
a control module configured to alter power that the paralleling power circuit receives from the alternate power source while the paralleling power circuit continues to power the load from both the photovoltaic array and the alternate power source concurrently;
wherein the control module determines at least one operating point of the photovoltaic array from sensor data, the at least one operating point being reached in response to the alteration of the amount of power that the paralleling power circuit receives from the alternate power source.

2. The system of claim 1, wherein the alternate power source includes an alternating current source.

3. The system of claim 1, wherein the at least one operating point is determined for a light level detected by a light sensor.

4. The system of claim 1, wherein the control module is further configured to determine a plurality of operating points for each one of a plurality of light levels in calibration table.

5. The system of claim 1, wherein the control module is further configured to alter the amount of power that the paralleling power circuit receives from the alternate power source in response to one or more entries in a calibration table expiring.

6. The system of claim 1, wherein the paralleling power circuit comprises ORing diodes.

7. The system of claim 1 further comprising a power converter configured to supply the paralleling power circuit with power from the alternate power source, wherein the control module is further configured to:
receive a light level indicative of an amount of light received by the photovoltaic array;
determine a power point voltage from a calibration table for the light level; and
direct the power converter to supply the power point voltage to the paralleling power circuit.

8. An apparatus comprising:
a paralleling power circuit configured to power a load with a photovoltaic array and an alternate power source concurrently; and
a control module configured to modify an amount of power that the paralleling power circuit receives from the alternate power source;
wherein the load is concurrently powered by the photovoltaic array and the alternate power source during the modification of the amount of power that the paralleling power circuit receives from the alternate power source, and
the control module determines at least one operating point of the photovoltaic array from sensor data, the at least one operating point reached in response to the modification of the amount of power that the paralleling power circuit receives from the alternate power source.

9. The apparatus of claim 8 further comprising a power converter configured to supply the paralleling power circuit with power from the alternate power source, wherein the power converter is configured to modify the amount of power that the paralleling power circuit receives from the alternate power source in response to receipt of a signal from the controller module.

10. The apparatus of claim 8 further comprising:
a battery charger configured to receive power from the photovoltaic array, wherein the battery charger and the load are configured to concurrently receive power from the photovoltaic array, wherein the control module is further configured to:
alter an amount of power that the battery charger receives from the photovoltaic array while the photovoltaic array continues to power both the battery charger and the load concurrently, and
determine at least one second operating point of the photovoltaic array from sensor data, the at least one second operating point being reached in response to the alteration of the amount of power that the battery charger receives.

11. The apparatus of claim 10, wherein the alternate power source includes a battery, and the battery is charged by the battery charger.

12. The apparatus of claim 10, wherein the alternate power source includes an alternating current power source.

13. The apparatus of claim 10, wherein the control module is further configured to modify the amount of power that the paralleling power circuit receives from the alternate power source in response to a determination that the load consumes more power than the photovoltaic array can provide, and to alter the amount of power that the battery charger receives from the photovoltaic array in response to a determination that the load consumes less power than the photovoltaic array can provide.

14. The apparatus of claim 8, wherein the control module is configured to modify the amount of power that the paralleling power circuit receives from the alternate power source in response to a determination that the load consumes more power than the photovoltaic array can provide and a determination that a detected light level matches a light level in a calibration table.

15. A method to determine operating points of a photovoltaic array, the method comprising:
powering a load with the photovoltaic array and an alternate power source concurrently;
adjusting an amount of power that the alternate power source supplies to the load while continuing to power the load with the alternate power source and the photovoltaic array concurrently; and
determining at least one operating point of the photovoltaic array from sensor data, the at least one operating point reached in response to said adjusting the amount of power that the alternate power source supplies to the load.

16. The method of claim 15 further comprising operating the photovoltaic array at a determined one of the at least one operating point by controlling the amount of power that the alternate power source supplies to the load.

17. The method of claim 15, wherein adjusting the amount of power that the alternate power source supplies comprises adjusting an output voltage of a power converter, the power converter supplying the paralleling power circuit with power from the alternate power source.

18. The method of claim 15 further comprising adjusting the amount of power that the alternate power source supplies in response to a determination that both the photovoltaic array and the alternate source power the load.

19. A system for determining operating points of a photovoltaic array, the system comprising:
a battery charger configured to receive power from the photovoltaic array, wherein the battery charger and a load are configured to concurrently receive power from the photovoltaic array;
a control module configured to alter an amount of power that the battery charger receives from the photovoltaic array while the photovoltaic array continues to power both the battery charger and the load concurrently, wherein:
the control module is further configured to determine at least one operating point of the photovoltaic array from sensor data, the at least one operating point being reached in response to the alteration of the amount of power that the battery charger receives.

20. The system of claim 19, further comprising a paralleling power circuit configured to power the load with both the photovoltaic array and a battery concurrently, the battery charged by the battery charger.
